(19) United States
(12) Patent Application Publication
(10) Pub. No.: US 2015/0309391 A1
(43) Pub. Date: Oct. 29, 2015

(54) PROTECTIVE HOUSING

(71) Applicant: SELEX ES LTD, Basildon Essex (GB)

(72) Inventors: David REEKIE, Basildon Essex (GB); Mark Edgar BRAY, Basildon Essex (GB)

(21) Appl. No.: 14/646,319

(22) PCT Filed: Oct. 22, 2013
(86) PCT No.: PCT/EP2013/072071

§ 371 Date: May 20, 2015

(30) Foreign Application Priority Data
Nov. 26, 2012 (GB) 1221244.5

(51) Int. Cl. G03B 17/02; G03B 17/56

(52) U.S. Cl. CPC G03B 17/02; G03B 17/561

(57) ABSTRACT

A protective housing for a camera system mounted on a platform is described. The housing is formed in a domed shape and covers sensitive optical systems. The housing is mounted on or forms part of the external housing of the seeker system. The housing is optically transparent whilst also being conductive. In this way, the housing allows transmission of multiple wavelengths of radiation through the housing whilst also acting so as to reduce radar cross section of the platform and preventing transmission of electromagnetic rf pulse in to the sensitive optical systems of the seeker system.

This invention relates to a protective housing. More specifically, but not exclusively, it relates to an optically transparent protective housing for a camera mounted on a platform.

On modern platforms, such as vehicles, aircraft and missiles, and in other fields such as radiation monitoring, sensitive monitoring equipment, such as IR cameras are often utilised. Such equipment must be protected from a harsh exterior environment and this is often achieved by use of optically transparent structures that do not inhibit the ‘view’ from such cameras. These housings are often domed and are manufactured from materials that are transparent to the wavelength of interest such as IR or visible. These domed housings may also form the external aperture of handheld camera equipment.

In cameras built for multi-spectral use, for example Medium Wave (MW) IR and Long Wave (LW) IR imaging, or even for all the bands from visible (˜400 nm) to LWIR (˜12-14 um), using the same external aperture, optical elements, such as the housing, with high transmission in all of the bands of interest must be used.

It is advantageous for these housings to be electrically conductive. Therefore, it is known to provide these housings with a conducting layer, either a continuous ‘sheet’ or with some form of ‘grid’ structure. The layer is ideally a conformal coating on the housing, although some housings may be conductive per se. There are two reasons that a conductive housing is required. The first is to prevent electromagnetic (EM) radiation, either a counter measure or simply innocently present in the environment, entering the camera body via the aperture of the optics and disrupting the electronics. Secondly, the radar cross-section of the platform, vehicle or missile is reduced thereby reducing its susceptibility to detection and counter-measures.

Many materials used in multi-spectral optics systems to date, for example Zinc Sulphide, do not conduct. Additionally, such materials are often not robust against erosion caused by particles in the environment or even rain. This is particularly true for super-sonic operation. A ‘hard’ coating is often required to avoid damage to the surface over time thereby significantly impacting performance.

Transparent conductive layers for application to protective housings are typically formed by a suspension of metal particles or metal oxides. These are expected to have higher optical loss in the IR and may have lower resistance to erosion. Other examples include those described in U.S. Pat. No. 6,180,030; US patent 20030201164; U.S. Pat. No. 3,698,946. However, these are limited to protective domes only transparent in the visible spectrum.

Further approaches have been utilised, for example the use of semiconductors Examples of such systems are disclosed in U.S. Pat. No. 5,824,418, and U.S. Pat. No. 5,724,180. Such systems use Germanium which is often used for 8-14 um operation and Si which is often used for 2-5 um operation. However these semiconductors cannot be easily formed as layers on complex structures or curved surfaces.

Single IR waveband domes may be made wholly of conducting materials, for example, Germanium may be used for Long Wave (LW) IR domes. If the Germanium (Ge) includes doping to allow conduction, this forms a barrier to electromagnetic waves. Robust coatings for single band domes such as Ge, are included in the work described in Proc. SPIE 2286, Window and Dome Technologies and Materials IV, 376 (Sep. 28, 1994).

None of the above systems provide for a protective housing including a layer that can be easily manufactured with low optical loss over multiple wavebands of interest, with low resistivity, and good resistance to erosion.

It has been stated publically that no long wave or multi-spectral material was sufficiently durable and that good IR transmitting materials are highly reflective at radio frequencies for this application. Additionally it has also been stated that there is no known material with adequate infrared transparency together with adequate electrical conductivity.

The present invention aims to provide such a solution.

According to the invention there is provided a protective housing for a camera mounted on a platform, the housing comprising a layer of graphene, the graphene being conductive yet acting so as to allow transmission of radiation through the housing.

The invention will now be described with reference to the following diagrammatic drawings in which:

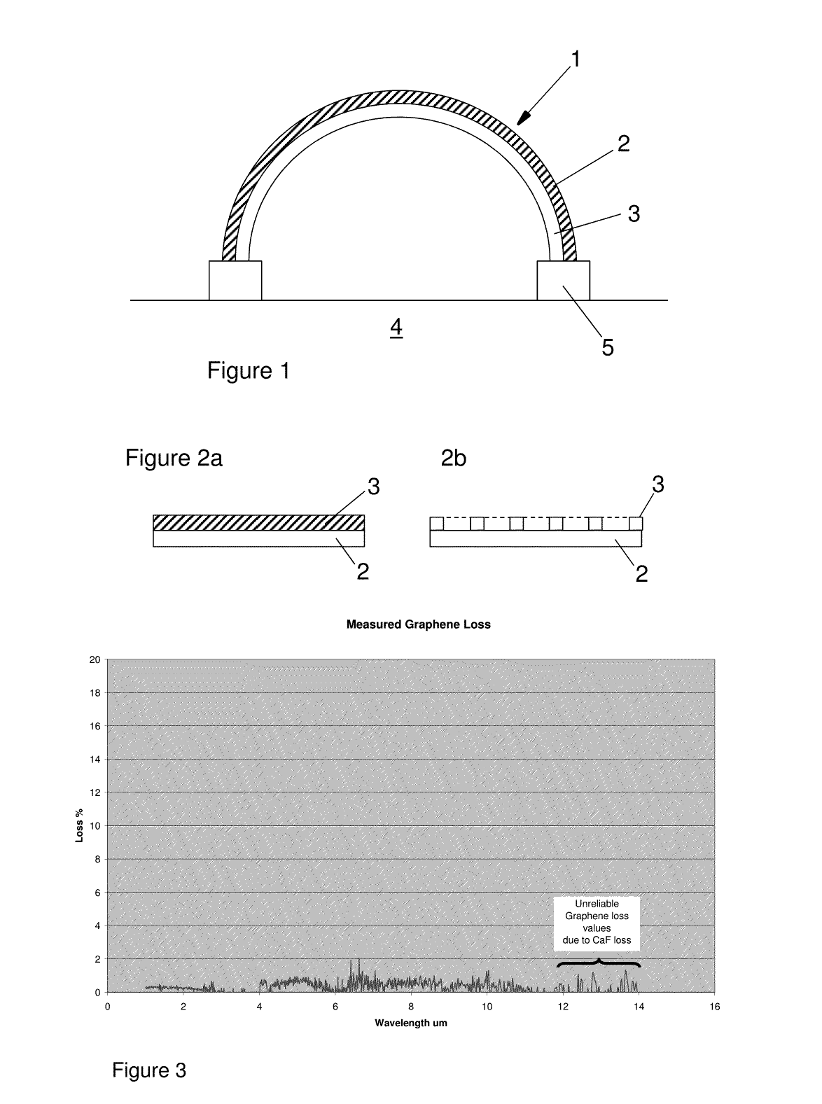

FIG. 1 is a cross-sectional, schematic diagram of one form of the invention showing a dome-shaped protective housing for an camera, the dome being mountable on the exterior surface of a vehicle, missile or other platform;

FIG. 2 is a magnified view of the domed housing of FIG. 1 showing a layer of one form of the invention, on the external surface of the dome.

FIG. 3 is a graph showing the optical loss in a system having a graphene coating on the dome-shaped housing, the loss shown being solely due to the graphene coating.

FIG. 1 shows a typical protective dome-shaped housing 1 for use in protecting sensitive equipment such as an IR camera system (not shown). The dome 1 may form the external aperture of the IR camera system (not shown).

In a first embodiment of the invention shown in FIG. 2, the dome 1 comprises a substrate 2 formed from Zinc Sulphide having a layer 3 of graphene deposited thereon. The graphene layer 3 may be in the form of a layer of one atom thickness of graphene deposited on the outside surface of the substrate 2 forming the dome 1. However, the layer 3 may be formed on the inside surface of the domed housing in order that the graphene is protected from the external environment.

It will be appreciated that the layer 3 may comprise multiple conformal layers of graphene each individual layer being of a single atom thickness.

Alternatively, the layer 3 may take the form of a single layer of graphene sandwiched between layers of suitable optically transparent material.

In the example described above, the dome 1 is mounted on the exterior surface of the platform 4 using suitable mountings 5.

The graphene layer 3 may be deposited on the substrate 1. However, it will be appreciated that any suitable manufacturing method capable of creating a layer 3 of graphene on the substrate 2 may be used.

The camera system (not shown) may be operative at a single wavelength or may operate over a number of discrete wavelength bands for example for multi-spectral use for MWIR and LWIR imaging, or even for all bands from visible (˜400 nm) to LWIR (˜12-14 um), using the same external aperture and protective housing.

In a second embodiment of the invention, the conductive layer 3 of graphene may take the form of a geometrical structure such as a grid or other required configuration. In this embodiment of the invention, the graphene layer may also form an antenna for a dual mode sensor. For example the graphene may be configured to act as a radio frequency (rf) transmitter or receiver via appropriate circuitry incorporated in the platform or camera. The structure and configuration of the graphene layer would be selected so as to produce an appropriate shape for such an application. It will be appreciated that there may be other uses for such a conductive structure within the housing and that the second embodiment is not limited to only rf antennae.

In a third embodiment of the invention, the conductive coating comprises a layered structure with Graphene sandwiched between matrix materials to make a composite. A suitable matrix material may be Zinc Sulphide. However, it will be appreciated that any other suitable optical transparent matrix material may be used.

In a fourth embodiment of the invention the housing comprises the external aperture of a camera, the graphene acting in a similar manner as described above, the housing forming part of the optical system of the camera.

Graphene has desirable properties for the applications described above. It is conductive, can be formed in layers on substrate materials, can be easily manufactured with low optical loss over multiple wavebands of interest, has low resistivity, and good resistance to erosion. Graphene is highly conductive its resistivity being approximately 35% lower than silver at room temperature. Furthermore, measurements have shown that Graphene has a breaking strength 200 times greater than steel, with a tensile modulus (stiffness) of 1 TPa (150,000,000 psi).

It will be appreciated that there are other similar applications for the use of graphene as an optically transparent yet conductive material. For example, it is envisaged that graphene may be used for IR transparent antennas on domes for hybrid rf/IR seeker systems on missiles, or other military applications or platforms. Additionally, graphene may be used as an IR transparent fuze on a domed housing capable of activating a lethal package upon target contact.

It will be appreciated that whilst graphene has the properties required to form a suitable conducting layer the form that the layer takes is not limited to the three examples discussed above and that any suitable form of graphene layer that achieved the objective described is envisaged.

1. A protective housing for a camera mounted on a platform, the housing comprising:
a layer of graphene, the graphene being conductive yet acting so as to allow transmission of imaging radiation through the housing whilst preventing radio frequency radiation being transmitted through the housing.

2. A protective housing according to claim 1 in which the housing comprises:
an external aperture of a camera.

3. A protective housing according to claim 1 in which the housing comprises:
a conformal layer of graphene formed on or within a substrate.

4. A protective housing according to claim 1 in which the housing comprises:
a grid-like structure of graphene formed on or within a substrate.

5. A protective housing according to claim 1 in which the housing comprises:
a graphene-substrate composite.

6. A protective housing according to claim 3 in which the substrate comprises:
Zinc Sulphide or other material having appropriate optical properties.

7. A protective housing according to claim 1 configured such that imaging radiation which will transmit through the housing can include radiation of a single wavelength, multiple discrete wavelengths or multiple ranges of wavelengths.

8. A protective housing according to claim 7 configured such that imaging radiation which will transmit through the housing can include radiation suitable for MWIR and LWIR imaging, or radiation of all wavelengths from visible to LWIR.

9. A protective housing according to claim 1 in which the housing is formed in a dome-like shape.

10. A camera system operative at a single discrete wavelength, in multiple discrete wavelengths or multiple ranges of wavelengths, the camera system being configured for mounting on an external surface of a platform, the camera system comprising:
a single external aperture, the aperture containing a layer of graphene, the graphene being conductive yet acting to allow transmission of imaging radiation through the housing whilst preventing transmission of radio frequency radiation through the housing.

11. A camera system according to claim 10 in which the external aperture comprises:
a domed-structure.

12. A camera system according to claim 9 configured such that radiation which will transmit through the aperture can include radiation suitable for MWIR and LWIR imaging, or radiation of all wavelengths from visible to LWIR.

13. A seeker system comprising:
a protective housing, the seeker system being configured for operation at one or more wavelengths or ranges of wavelengths, the housing being optically transparent whilst also being conductive and acting to reduce a radar cross section of a missile and protecting the seeker system from rf EM pulse.

14. A seeker system according to claim 13 in which the housing comprises:
graphene.

15. A seeker system according to claim 14 in which the graphene is formed in a grid-like structure.

16. A seeker system comprising:
a protective housing, the protective housing containing a graphene layer, the graphene layer being configured so as to act as a radio frequency transmitter or receiver via circuitry incorporated in the seeker system.

17. (canceled)

18. A protective housing according to claim 2 in which the housing comprises:
a conformal layer of graphene formed on or within a substrate.

19. A protective housing according to claim 2 in which the housing comprises:
a grid-like structure of graphene formed on or within a substrate.

20. A protective housing according to claim 5 in which the substrate comprises:
Zinc Sulphide or any other material having appropriate optical properties.

21. A protective housing according to claim 6 in which the housing is formed in a dome-like shape.
